(19) United States
(12) Patent Application Publication
(10) Pub. No.: US 2009/0240903 A1
(43) Pub. Date: Sep. 24, 2009

(54) Methods and Apparatus for Translating a System Address

(75) Inventors: William F. Sauber, Georgetown, TX (US); Mukund Purshottam Khatri, Austin, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: DELL PRODUCTS L.P., Round Rock, TX (US)

(21) Appl. No.: 12/052,727

(22) Filed: Mar. 20, 2008

(51) Int. Cl. G06F 12/10; G06F 12/16

(52) U.S. Cl. 711/161; 711/206; 711/E12.058; 711/E12.103

(57) ABSTRACT

A method for translating a system address includes providing a first system address to a firmware and retrieving a first translation data corresponding to a memory configuration from storage. The first system address is translated into a first physical location utilizing the first translation data, and the first physical location is outputted.

### BACKGROUND

1. Technical Field

The present disclosure relates generally to the field of information handling systems. More specifically, but without limitation, the present disclosure relates to translating system addresses.

2. Background Information

As the value and use of information continues to increase, individuals and businesses seek additional ways to process and store information. One option available to users is an information handling system (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In an IHS, a dynamic random access memory (DRAM) may be utilized to store applications and data. A DRAM may lose data if it is not refreshed periodically, whereas static memory may not lose data if power is removed from the memory. A DRAM module may include a nonvolatile memory storing serial presence detect (SPD) data utilized to provide information on the memory module's architecture, available functions, timing information, as well as other information. The SPD data may be utilized to determine memory module compatibility with an IHS as well as to properly configure the IHS to utilize the memory module. An IHS may accommodate several different memory sizes, memory types, population of slots, row address strobe (RAS) options, column address strobe (CAS) options, or the like. Further, several different manufacturers provide one or more memory controller(s) to manage communication between a DRAM and other components of an IHS. The flexibility that an IHS provides results in a substantial number of potential memory configurations that may be implemented.

In an IHS, physical locations of a DRAM may be mapped to system addresses in order to optimize operation. Note that a system address is sometimes referred to as a logical address, and a physical location is sometimes referred to as physical address. Different memory configurations may result in different mapping techniques. For example, an IHS utilizing one DRAM module may map addresses in a different manner than it would if four DRAM modules were present. Further, a memory controller manufactured by Company A may map addresses in a different manner than a memory controller manufactured by Company B. Consequently, because a substantial number of memory configurations may be possible, a substantial number of mapping techniques may exist. Some software, such as system diagnostics, may require a physical location of detected data errors in order to isolate and replace failing memory locations. However, because a mapping technique may be specific to a particular memory configuration, several different versions of code may be needed to accommodate different memory configurations. In the case that the memory configuration is changed or modified, a code operating to translate a system address into a physical location may not correspond to the particular memory configuration provided.

Thus a need remains for methods, apparatus, and media for translating a system address into a physical location for any memory configuration. Further, a need remains for a universal entry point at which software may provide a system address for translation into a physical location.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the disclosure provides a method for translating a system address. The method includes providing a first system address to a firmware and retrieving a first translation data corresponding to a memory configuration from a storage. The first system address is translated into a first physical location utilizing the first translation data and the first physical location outputted.

Another aspect of the disclosure provides an apparatus for translating a system address including a processor for loading software, wherein the software provides a first system address to a firmware. The apparatus also includes a storage including a first memory region storing a first translation data, wherein the first translation data is utilized to translate the first system address into a first physical location. A second memory region stores the firmware, and the firmware causes the first translation data to be retrieved for translating the first system address and provides the first physical location to the software.

Yet another aspect of the disclosure provides a computer-readable medium having computer-executable instructions for performing a method including the steps of providing a first system address to a firmware, and retrieving a first translation data corresponding to a memory configuration from a storage. The method further includes translating the first system address into a first physical location utilizing the first translation data, and outputting the first physical location.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents a schematic of an information handling system according to the present disclosure;

FIG. 2 represents an illustrative implementation of a memory module within an IHS;

FIG. 3 represents an illustrative implementation of firmware mapping a system address to a physical location;

FIG. 4 represents an illustrative implementation of a memory configuration table;

FIG. 5 represents an illustrative implementation of a general information table;

FIG. 6 represents an illustrative implementation of a data structure utilized for address translation when interleaved criteria are met;

FIG. 7 represents an illustrative implementation of a data structure utilized for address translation when interleaved criteria are not met; and

FIG. 8 represents a flow chart of a translation process utilizing data structures.

### DETAILED DESCRIPTION

Although the invention as been described with reference to specific implementations, it will be understood by those skilled in the art that various changes may be made without departing from the spirit or scope of the invention. Various examples of such changes have been given in the forgoing description. Accordingly, the disclosure of implementations of the disclosure is intended to be illustrative of the scope of the invention and is not intended to be limiting. It is intended that the scope of the invention shall be limited only to the extent required by the appended claims. For example, to one of ordinary skill in the art, it will be readily apparent that the information handling system discussed herein may be implemented in a variety of implementations, and that the forgoing discussion of certain of these implementations does not necessarily represent a complete description of all possible implementations.

For simplicity and clarity of illustration, the drawings and/or figures illustrate the general manner of construction, and descriptions and details of well known features and techniques may be omitted to avoid unnecessarily obscuring the disclosure.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

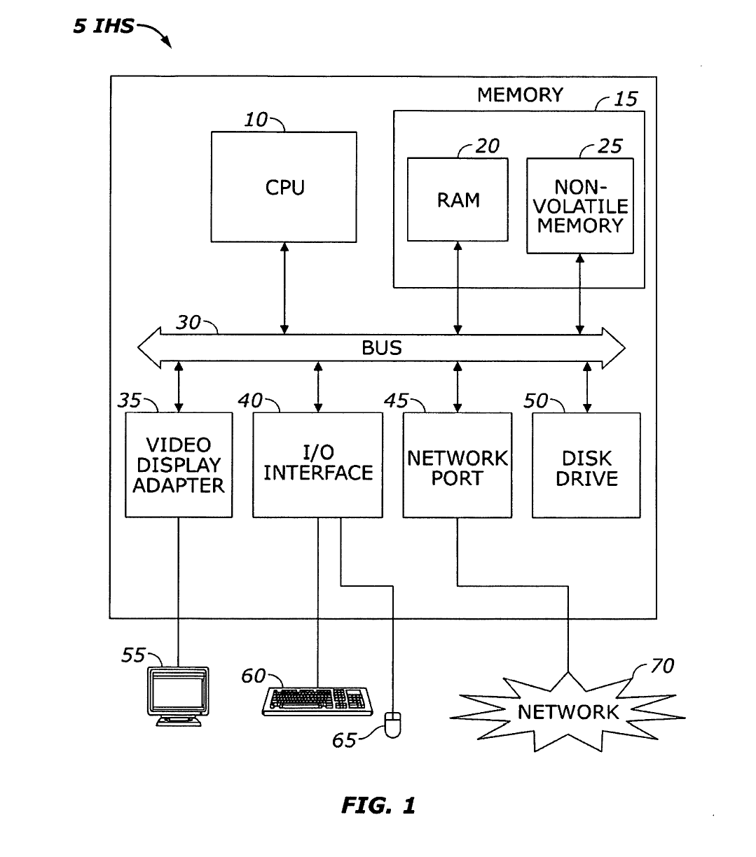

FIG. 1 illustrates one possible implementation of an IHS 5 comprising a CPU 10. It should be understood that the present disclosure has applicability to information handling systems as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory and electrically erasable programmable read-only memory (EEPROM). The firmware program (stored in nonvolatile memory 25) may contain, programming and/or executable instructions required to control a keyboard 60, mouse 65, video display 55 and/or other input/output devices not shown here. The memory may also comprise RAM 20. The operating system and application programs may be loaded into the RAM 20 for execution.

The IHS 5 may be implemented with a network port 45 to permit communication over a network 70 such as a local area network (LAN) or a wide area network (WAN). As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

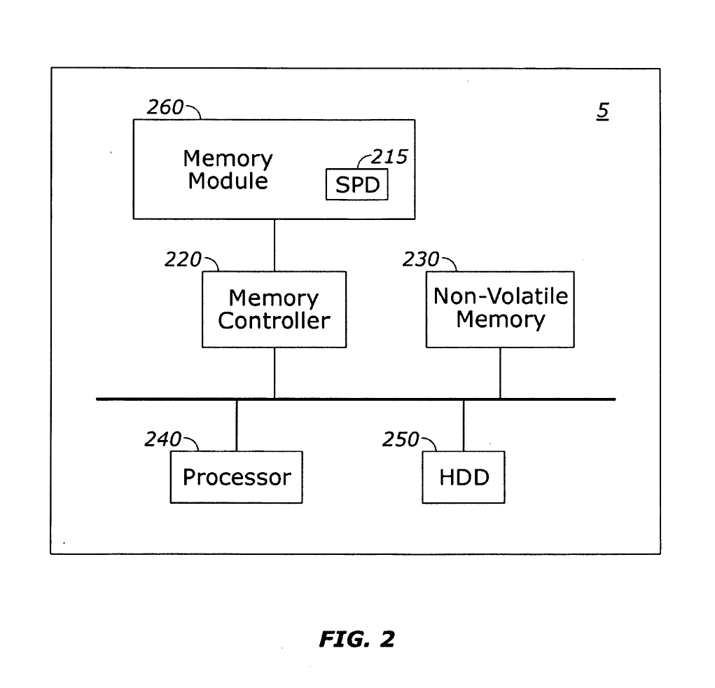

FIG. 2 provides an illustrative implementation of a memory module indicated generally at 210 within an IHS. A processor 240 in an IHS 5 may be coupled to several different storage devices, each storage device utilized for different purposes. By way of example, a hard disk drive (HDD) 250 may store an operating system (OS), programs, applications, files, or the like. Also, a non-volatile memory 230 may store a basic input output system (BIOS) utilized to identify and initialize hardware components in an IHS 5.

An IHS 5 may also contain one or more memory modules 210 utilized as system memory. The system memory may be utilized by a processor 240 to temporarily store an OS, critical applications, and other data. A memory module 210 may include a serial presence detect (SPD) device 215 storing data on an electrically erasable programmable read only memory (EEPROM). The EEPROM may serially provide data including information regarding module architecture, available functions, timing information, manufacturer information, serial number, and other information about the module. When an IHS 5 is booted, a memory controller 220 may access SPD data through a bus, such as an I²C bus or SMBus, to determine if a memory module 210 is compatible with an IHS 5. In other implementations, more than one memory module 210 may be present in an IHS 5. Further, memory modules 210 are available in a variety of different sizes, clock speeds, as well as numerous additional parameter variations. The scope of the disclosure is not limited to any particular memory module configuration.

Several different types of memory modules 210 may be utilized in an IHS 5. Further, a memory module 210 may optionally provide additional features, such as error correction coding (ECC) utilizing extra bits to correct any detected errors. A memory controller 220 may manage data communication between a memory module 210 and other components in an IHS 5. For example, a memory controller 220 may manage addressing, read/write commands, refresh commands, and other necessary operations in order to allow the memory module 210 to read and/or store data as needed in an IHS 5. While only one memory controller 220 is shown, additional memory controllers may be present in an IHS 5.

As an application/program runs on an IHS 5, a portion of a memory module 210 may be designated for use by the application. A system address may correspond to an address within the designated portion of a memory module 210 used by an application. In general, a system address may not correspond to a physical address. A physical address, sometimes referred to as a physical location, may provide data indicating the location of data on a recording medium. For example, when an IHS 5 is booted, several registers and hardware may be configured according to SPD data read from a memory module 210. A system address may be mapped by a memory controller 220 to a physical address identified by an n tuple. An n tuple may represent a physical location in a memory module 210 by providing information regarding column address, row address, bank address, rank, module, channel, or any other suitable data. An n tuple may identify a physical location utilizing any combination of the information listed, including less than the information listed or additional information not listed. Address mapping may be performed in order to optimize performance in an IHS 5. However, the mapping performed may vary based on a particular memory configuration.

A memory configuration in an IHS 5 may be represented by the particular memory hardware present and the available features of the hardware such as ECC or non-ECC. The memory hardware may include components such as memory controller(s) and one or more memory modules. Further, the memory module may vary by type, size, CAS latency (CL), manufacturer, or the like. Because there are numerous memory controllers, memory module types and sizes, and memory module features, various potential memory configurations may be possible within an IHS 5. For example, an IHS 5 may have different memory controller(s) present, dual rank memory or quad rank memory, interleaved mode or non-interleaved mode, different row address strobe (RAS) options, or the like. It is recognized by one of ordinary skill in the art that there may be numerous potential memory configurations.

In order for an application to translate a system address into a physical location, complex coding may be needed to covert the system address to the corresponding physical location. Because the mapping performed may vary (i.e., based on memory controller, memory configuration, RAS options, etc.), different coding may be needed for different memory configurations. As a result of the numerous potential combinations, providing coding to translate a system address into a physical location for each potential memory configuration may be a challenge. For example, a diagnostics program may need to know the physical location in order to replace and isolate failing memory locations. However, in order to determine the physical locations, the diagnostic program would require different coding for each memory configuration for each IHS.

In order to provide a universal solution, an IHS 5 may utilize a portion of the non-volatile memory 230 for storing one or more data structures and/or algorithms. A data structure may be an organized structure such as, for example, a table which contains data regarding address translation. An algorithm may present a series of steps or instructions that may be performed for address translation. A non-volatile memory 230 may be a flash or any suitable type of nonvolatile memory. Each data structure may be associated with a particular memory configuration. In one implementation, a memory 230 may store only one data structure and the data structure stored in the memory 230 is updated each time memory controller initialization is executed. In another implementation, data structures may be relatively simple, which may allow multiple data structures corresponding to a plurality of memory configurations to be stored. An algorithm may be used in conjunction with a data structure to map a system address to a physical location in a memory module 210. In another implementation, an address translation technique may be purely algorithmic or purely based on a data structure.

An algorithm may operate in several possible modes. In a first mode, information regarding a particular address of interest may be extracted from a memory controller 220 and a system address may be generated. In a second mode, a system address may be converted to an n tuple describing the physical location. A SPD address may determine what information on a memory module 210 is to be returned. For example, a SPD module 215 may allow the presence of a memory module to be detected. Once a memory module 210 is detected, a SPD address may include data indicating what information is to be retrieved from the memory module 210. In another implementation, a system address may be mapped to a SPD address and memory channel.

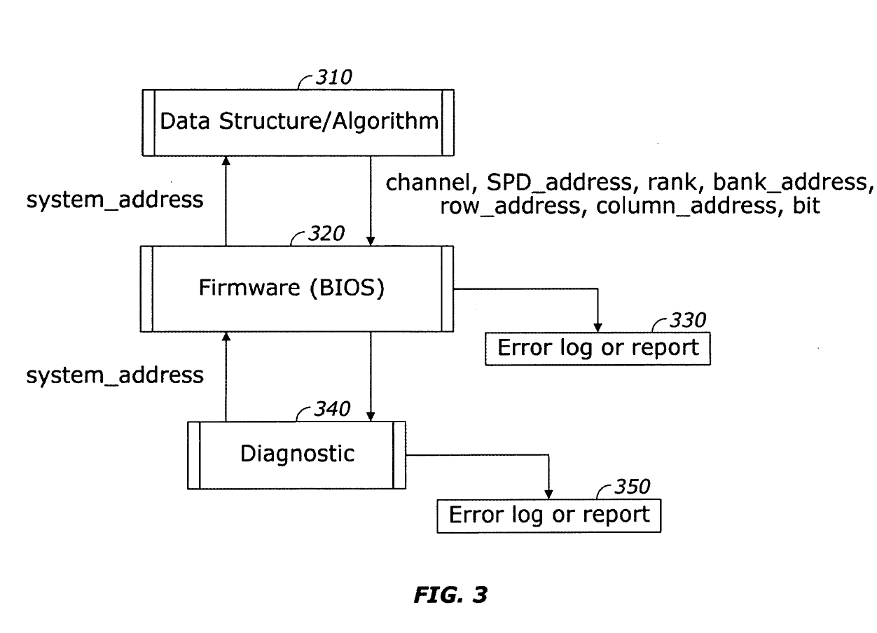

FIG. 3 represents an illustrative implementation of firmware mapping a system address to a physical location. Diagnostics 340 and/or operating systems may need to determine a physical location of an error in order to isolate and replace failing memory locations. Additionally, the physical location information may be useful for dual in-line memory module (DIMM) error logging. For example, a diagnostic 340 may be a program operating to locate problems with hardware and/or software, such as an operating system (OS), in an IHS or a network of IHSs. A diagnostic 340 may identify error locations utilizing a system address, and provide the system address to firmware 320. Firmware 320 may be a computer program embedded in a hardware device, and in some cases, firmware 320 may be part of a BIOS or added to a BIOS. The firmware 320 may include an interface to an algorithm and/or data structure 310 stored in a memory such as a flash memory or the like. A data structure 310 may provide specific information to an algorithm 310 about a current memory configuration. Furthermore, the data structure 310 may be updated each time memory initialization is executed. In one implementation, a data structure may be null for purely algorithmic mapping. An algorithm 310 may operate in at least one possible mode. In one mode, information about an error may be extracted from a memory controller and a system address is generated. In a second mode, a system address may be converted to an n tuple describing a physical location. The n tuple may be provided to firmware 320, and the firmware 320 may also provide the n tuple to a diagnostic 340. Firmware 320 and/or a diagnostic 340 may then generate an error log or report 330, 350. Firmware 320 may provide a universal way for diagnostics 340 to access memory controller specific address mappings. In other words, the present disclosure may provide a constant, universal entry point for diagnostics to utilize when a physical location is needed. Diagnostics may no longer require different coding for different memory configurations to determine a physical location. A diagnostic may simply request information regarding a physical location corresponding to a system address from the firmware 320. Optionally, a firmware may be included with a BIOS to append physical location information. In another implementation, an application or system software may need to locate a physical location in a memory module. The application or system software may replace or may also be communicatively coupled to the firmware 320 to allow physical location information to be received.

FIGS. 4-8 provide an example of a translation process for an IHS. The example IHS represents a four dual in-line memory module (DIMM) unbuffered memory system which may only allow DIMMs with x8 devices. The example IHS, information tables, and algorithms discussed are provided for illustration only. While this example provides a limited scope of memory configurations, it is recognized by one of ordinary skill in the art that the present invention may be applied to any suitable memory configurations within the scope of the claims. The various methods, apparatus, and media discussed in the present disclosure contemplate various additional implementations within the scope of the claims in addition to the illustrative implementation to be discussed regarding FIGS. 4-8.

FIG. 4 provides an illustrative implementation of a memory configuration table. During system initialization, an IHS may populate a memory configuration table utilizing the SPD devices of each DIMM in an IHS. For each of the DIMM sockets the table may provide data regarding the device density and the number of ranks retrieved from the SPD devices. When a DIMM is not present in a DIMM socket, a device density value may be null and a number of ranks may be zero. When a memory module is present in a DIMM socket the device density may range from 512 MB to 1024 MB, and the number of ranks may be 1 (single-rank) or 2 (dual-rank).

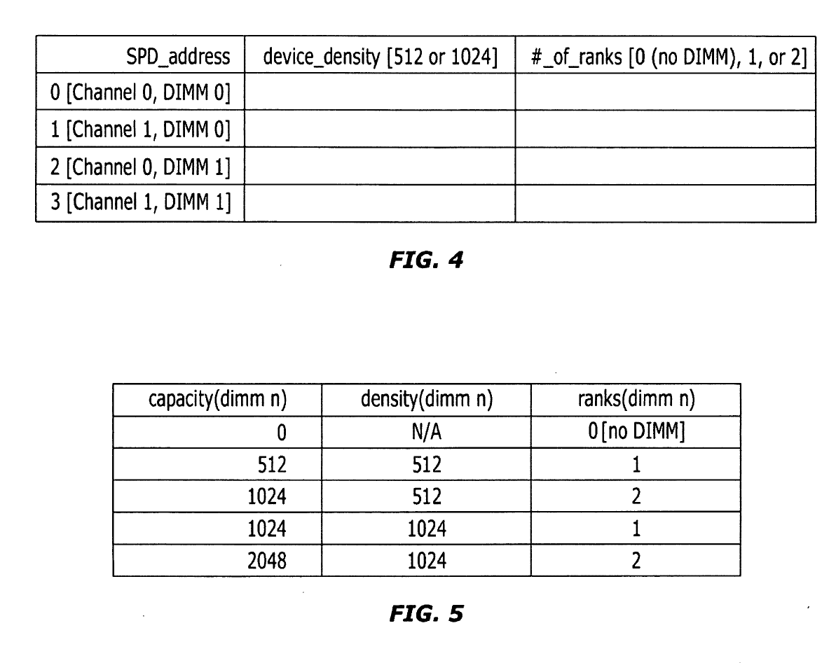

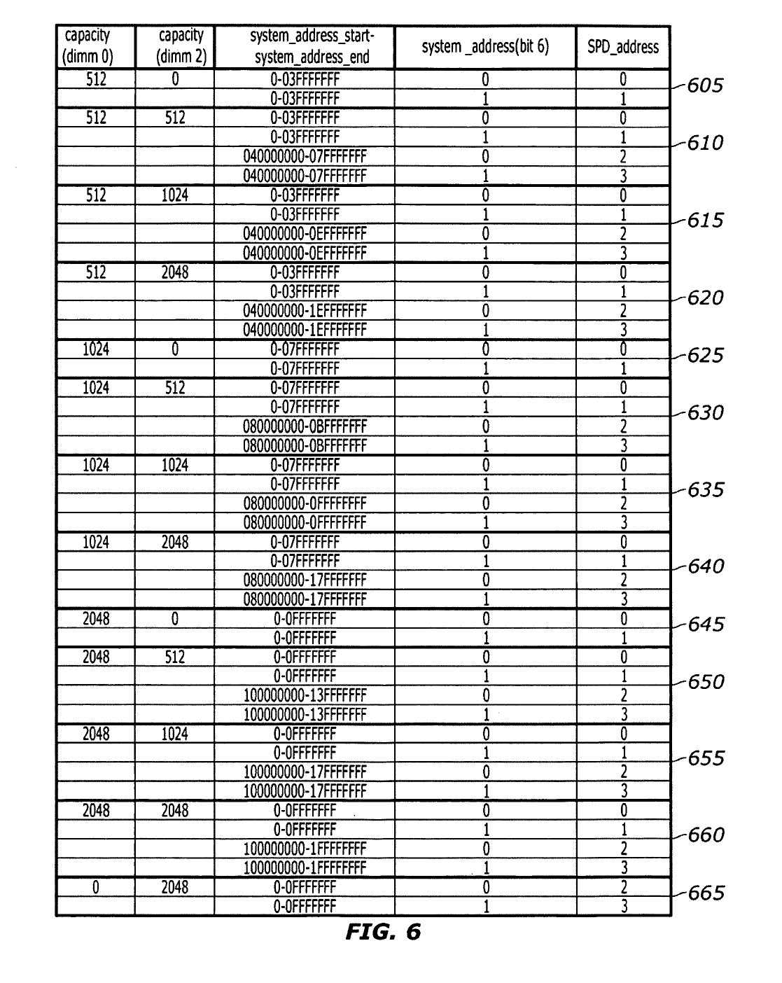

FIG. 5 represents an illustrative implementation of a general information table. Based on the density and number of ranks for each DIMM module populated in the memory configuration table, the capacity of each DIMM module in an IHS can be determined utilizing the general information table. For example, if a DIMM in socket 0 has a density of 512 MB and a single rank, then the capacity of the DIMM may be 512 MB. If a DIMM in socket 1 has a density of 512 and dual ranks, then the capacity of the DIMM may be 1024 MB.

FIG. 6 represents an illustrative implementation of a data structure utilized for address translation when interleaved criteria are met. When interleave criteria are met (discussed in detail below), an IHS may build a data structure corresponding to a memory configuration during system initialization. An IHS may determine the capacity of memory modules in DIMM sockets 0 and 1 and DIMM sockets 2 and 3 utilizing a memory configuration table and a general information table. In the data structure shown, it may be assumed that interleaved memory modules are the same capacity. However, interleaved memory modules of different capacities may be accommodated utilizing a different data structure. When the capacities of the memory modules are determined, a corresponding portion of the data structure may be built during system initialization. Each of the separate regions 605, 610, 615, 620, 625, 630, 635, 640, 645, 650, 655, 660, and 665 may correspond to possible memory configurations in an interleaved mode. While the data structure shown provides information for many potential memory configurations with memory modules of different capacities, only one region corresponding to a current memory configuration may be need after system initialization. For example, if the capacity of four DIMMs in sockets 0-3 are 512 MB, then only the second region 610 may need to be built during system initialization.

The data structure provides a system address start and system address end, system address, and SPD address for each potential memory configuration. The system address start and the system address end provide the starting and ending addresses for system addresses for each memory module in an interleaved mode. In one implementation, bit 6 of a system address may be used to select a memory channel. Additionally, a SPD address may indicate the memory socket for a memory module. Each row in the data structure may provide information regarding one memory module. For example, when 512 MB memory modules are present in sockets 0 and 2, the first two rows may provide data for a first and second memory module and the next two rows may provide data corresponding to a third and fourth memory module. Utilizing the system address start, the system address end, bit 6 of the system address, and the SPD address a physical location may easily be determined.

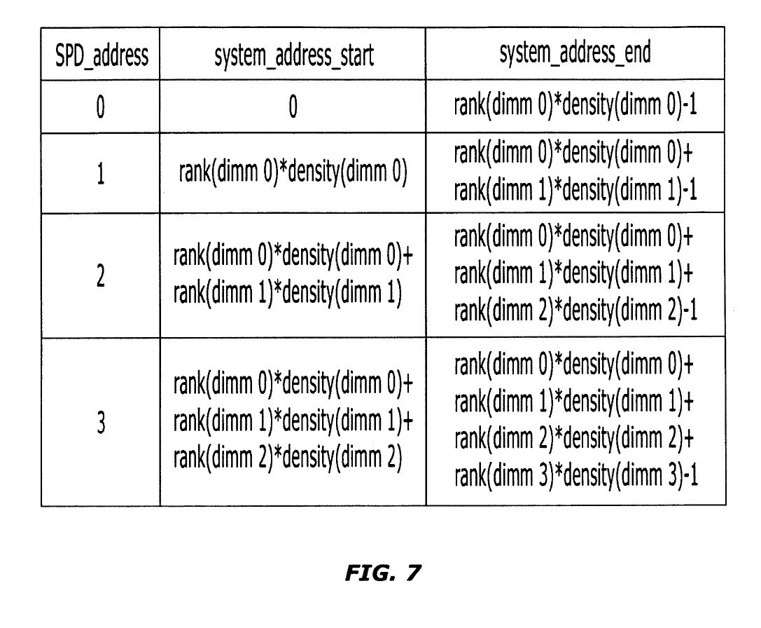

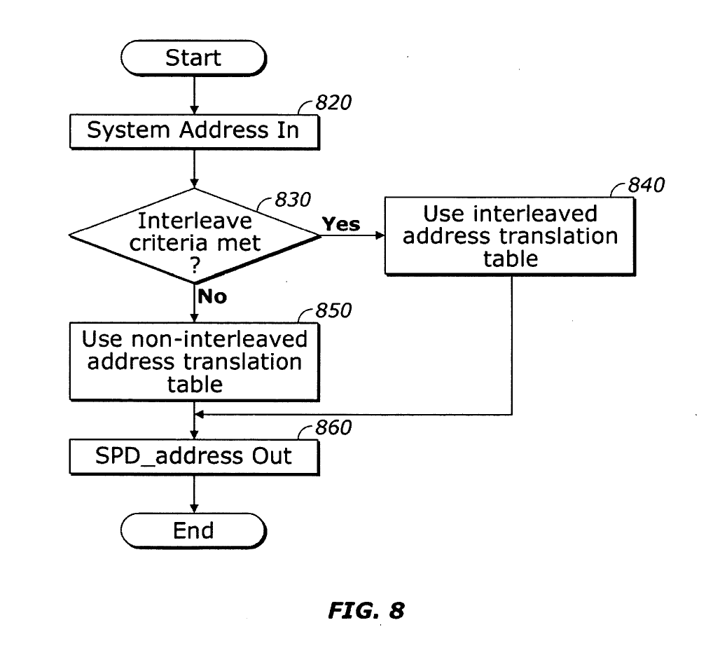

FIG. 7 provides an illustrative implementation of a data structure utilized for address translation when interleaved criteria are not met. When interleaved criteria are not met, the memory modules in an IHS may not operate in an interleaved mode. As a result, system addresses may be assigned sequentially for each of the memory modules. The capacity of each memory module may be determined by multiplying the number of ranks by the density, and system addresses may be assigned sequentially to each of memory modules. For example, the a first memory module in socket 0 may have a system address start of 0, and an system address end corresponding to the size of the first memory module (i.e., [# of ranks for DIMM 0]*[density of DIMM 0]−1). The system address start of a second memory module in socket 1 may continue from the system address end of the first memory module and the system address end may correspond to the size of the second memory module. The density in FIG. 7 may imply the actual number of bits (e.g., 512 may have a density of 536, 870, 912 bits).

FIG. 8 provides a flow chart of a translation process utilizing data structures such as shown in FIGS. 4-7. When an IHS is initialized one or more data structures such as a memory configuration table (e.g., FIG. 4), a general information table (e.g., FIG. 5), an interleaved address translation table (e.g., FIG. 6), and a non-interleaved address translation table (e.g., FIG. 7) may be built. Once the IHS is initialized, the firmware may receive requests for address translation. The translation process shown in FIG. 8 may be repeated each time an address translation request is received. In the first step 820 of the translation process, a system address may be received by the firmware.

In order to properly translate the system address in step 830, it must be determined if interleave criteria are met. For example, interleaved criteria may be met if several conditions are met. First, memory modules in SPD address 0 and SPD address 1 should have the same device density and number of ranks. Second, memory modules in SPD address 2 and SPD address 3 should also have the same device density and number of ranks as well. If both conditions are met, then it implies that the capacity of memory modules in SPD address 0 and SPD address 2 may be equal and the capacity of memory modules in SPD address 1 and SPD address 3 may be equal.

If the interleave criteria are met, then a portion of the interleave address translation table (e.g., FIG. 6) may be utilized for address translation in step 840. As discussed previously, only a portion of an interleaved address translation table corresponding to a present memory configuration may be needed. After system initialization only one region of FIG. 6 corresponding to the present memory configuration may exist. If the interleaved criteria are not met, then a non-interleaved address translation table may be utilized for address translation in step 850. After address translation is performed utilizing an interleaved or non-interleaved address translation table, an SPD address may be outputted in step 860. As stated previously, the translation process discussed in FIG. 8 illustrates one of numerous potential translation processes and the invention is not in any way limited to the translation process discussed. As discussed regarding FIG. 3, the firmware may provide a universal entry point for applications to request an address translation. As a result, of the numerous potential memory configurations, several potential translation processes may be utilized. In order to provide a universal entry point to request address translation, any suitable translation process may be utilized in the present invention.

Methods of the present disclosure, detailed description and claims may be presented in terms of logic, software or software implemented aspects typically encoded on a variety of media or medium including, but not limited to, computer-readable medium/media, machine-readable medium/media, program storage medium/media or computer program product. Such media may be handled, read, sensed and/or interpreted by an IHS. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional junctions for couplings/links described herein.

What is claimed is:

1. A method for translating a system address, the method comprising:
providing a first system address to a firmware;
retrieving a first translation data corresponding to a memory configuration from a storage device;
translating the first system address into a first physical location utilizing the first translation data; and
outputting the first physical location.

2. The method of claim 1, wherein the firmware is a basic input/output system (BIOS).

3. The method of claim 1, wherein the first translation data comprises a first data structure and a first algorithm, and the first data structure is utilized by the first algorithm to translate the first system address into the first physical location.

4. The method of claim 1, wherein the first translation data is a first algorithm, a first data structure, or a combination of a second algorithm and a second data structure.

5. The method of claim 1, wherein the first physical location comprises an n tuple, the n tuple comprising a value selected from the group consisting of a column address, a row address, a bank address, a rank, a SPD address, a memory channel, and a combination thereof.

6. The method of claim 1 further comprising:
updating the first translation data in accordance with a current memory configuration each time one or more memory modules are initialized.

7. The method of claim 1, wherein the firmware provides a universal entry point for accessing the first translation data.

8. An apparatus for translating a system address comprising:
a processor for executing software, wherein the software provides a first system address to a firmware; and
a storage comprising,
a first memory region storing a first translation data, wherein the first translation data is utilized to translate the first system address into a first physical location;
a second memory region storing the firmware, wherein the firmware causes the first translation data to be retrieved for translating the first system address, and the firmware provides the first physical location to the software.

9. The apparatus of claim 8, wherein the first translation data comprises a first data structure and a first algorithm, and the first data structure is utilized by the first algorithm to translate the first system address into the first physical location.

10. The apparatus of claim 8, wherein the first translation data is a first algorithm, a first data structure, or a combination of a second algorithm and a second data structure.

11. The apparatus of claim 8, wherein the first physical location comprises an n tuple, the n tuple comprising a value selected from the group consisting of a column address, a row address, a bank address, a rank, a SPD address, a memory channel, and a combination thereof.

12. The apparatus of claim 8, wherein the first translation data stored by the first memory is updated in accordance with a current memory configuration each time one or more memory modules are initialized.

13. The apparatus of claim 8, wherein the firmware provides a universal entry point for accessing the first translation data.

14. A computer-readable medium having computer-executable instructions for performing a method comprising:
providing a first system address to a firmware;
retrieving a first translation data corresponding to a memory configuration from a storage device;
translating the first system address into a first physical location utilizing the first translation data; and
outputting the first physical location.

15. The computer-readable medium of claim 14, wherein the firmware is a basic input/output system (BIOS).

16. The computer-readable medium of claim 14, wherein the first translation data comprises a first data structure and a first algorithm, and the first data structure is utilized by the first algorithm to translate the first system address into the first physical location.

17. The computer-readable medium of claim 14, wherein the first translation data is a first algorithm, a first data structure, or a combination of a second algorithm and a second data structure.

18. The computer-readable medium of claim 14, wherein the first physical location comprises an n tuple, the n tuple comprising a value selected from the group consisting of a column address, a row address, a bank address, a rank, a SPD address, a memory channel, and a combination thereof.

19. The computer-readable medium of claim 14, wherein the method further comprises:
updating the first translation data in accordance with a current memory configuration each time one or more memory modules are initialized.

20. The computer-readable medium of claim 14, wherein the firmware provides a universal entry point to access the first translation data.
